(19) United States
(12) Patent Application Publication
(10) Pub. No.: US 2019/0236654 A1
(43) Pub. Date: Aug. 1, 2019

(54) ADAPTIVE ONLINE ADVERTISEMENT FILTER

(71) Applicant: Patrick Clinger, Foothill Ranch, CA (US)

(72) Inventor: Patrick Clinger, Foothill Ranch, CA (US)

(21) Appl. No.: 15/885,379

(22) Filed: Jan. 31, 2018

(51) Int. Cl. G06Q 30/02; H04L 29/06

(52) U.S. Cl. CPC G06Q 30/0277; G06Q 30/0275; H04L 63/1441; H04L 63/1416; H04L 63/101

(57) ABSTRACT

A method of adaptively filtering online advertisements may include loading, by a browser at a client, a webpage that includes an advertisement position. In response to the loading of the webpage, the browser may send, to an adaptive filter platform, an indication configured to cause the adaptive filter platform to send, to the browser, advertisement filter code and a block list. The browser may receive, from the adaptive filter platform, the advertisement filter code and a block list. The browser may execute the advertisement filter code to intercept bids for placing an advertisement in the advertisement position. The bids may be intercepted based on the block list provided by the adaptive filter platform. The interception of the bids may prevent a corresponding advertisement from being placed in the advertisement position. Related systems and articles of manufacture, including computer program products are also disclosed.

### TECHNICAL FIELD

The subject matter described herein relates generally to online advertisements and more specifically to an adaptive online advertisements filter.

### BACKGROUND

Online advertising is a ubiquitous form of delivering promotional material to consumers over the Internet. For example, a webpage may include one or more display advertisements (e.g., banner advertisements, frame advertisements, and/or the like) that use Java applets, Hypertext Markup Language (HTML), Adobe® Flash®, and/or the like to provide interactive and/or multimedia elements such as, for example, videos, audio, animation, forms, buttons, and/or the like.

### SUMMARY

Systems, methods, and articles of manufacture, including computer program products, are provided for adaptively filtering online advertisements. In one aspect, there is provided a system for adaptively filtering online advertisements at a browser. The system may include at least one data processor and at least one memory. The at least one memory may store instructions that result in operations when executed by the at least one data processor. The operations may include: loading, by a browser at a client, a webpage that includes at least one advertisement position; in response to the loading of the webpage, sending, by the browser and to an adaptive filter platform, an indication configured to cause the adaptive filter platform to send, to the browser, an advertisement filter code and a block list; in response to the sending of the indication, receiving, at the browser and from the adaptive filter platform, the advertisement filter code and the block list; and executing, by the browser, the advertisement filter code to intercept one or more bids for placing an advertisement in the at least one advertisement position on the webpage, the one or more bids being intercepted based at least on the block list, and the interception of the one or more bids preventing a corresponding advertisement from being placed in the at least one advertisement position.

In some variations, one or more features disclosed herein including the following features can optionally be included in any feasible combination. The block list can include one or more identifiers of advertisements, advertisers, and/or advertising networks.

In some variations, a first bid and a second bid can be received at the browser. The first bid can be associated with a first adverting network and corresponding to a first advertisement from a first advertiser. The second bid can be associated with a second adverting network and corresponding to a second advertisement from a second advertiser. The first bid can be intercepted based at least on the block list. The first bid can be intercepted based at least on the one or more identifiers of the first advertisement, the first advertiser, and/or the first advertising network being included in the block list. The second advertisement can be rendered in the browser in the at least one advertisement position on the webpage. The browser executing the advertisement filter code can generate analytics data based at least on the rendering of the second advertisement. The analytics data can indicate whether the second advertisement includes unwanted content, triggers an unauthorized action, and/or degrades performance of the client. At least a portion of the analytics data can be sent to the adaptive filter platform.

In some variations, the generation of the analytics data can include detecting one or more changes to the webpage caused by the rendering of the second advertisement on the webpage. In response to determining that the one or more changes include an audio element and/or video element that is currently playing, has not been muted, and/or is not triggered by user interaction, analytics data can be generated to indicate that the second advertisement includes unwanted content.

In some variations, the generation of the analytics data can include detecting one or more user interactions with the webpage that are capable of triggering an unloading of the webpage. The unloading of the webpage can be detected. In response to determining that the unloading of the webpage is not triggered by the one or more user interactions, analytics data can be generated to indicate that the second advertisement triggers an unauthorized action comprising an unauthorized unloading of the webpage.

In some variations, the generation of the analytics data can include determining a first quantity of time required to run a snippet of code prior to the rendering of the second advertisement on the webpage. The generation of the analytics data can further include determining a second quantity of time required to run the snippet of code subsequent to the rendering of the second advertisement on the webpage. In response to determining that the second quantity of time exceeds the first quantity of time, analytics data can be generated to indicate that the second advertisement degrades the performance at the client.

In some variations, the generation of the analytics data can include determining a distance on the webpage scrolled by a user of the browser, a size of a viewport at the browser, a position of the second advertisement on the webpage, and a size of the second advertisement. The generation of the analytics data can further include detecting that the second advertisement and/or a frame of the second advertisement gaining focus from the browser. That the second advertisement and/or the frame of the second advertisement was not visible when the second advertisement gained focus from the browser can be determined based at least on the distance on the webpage scrolled by the user, the size of the viewport at the browser, the position of the second advertisement on the webpage, and/or the size of the second advertisement. In response to determining that the second advertisement was not visible when the second advertisement gained focus from the browser, analytics data can be generated to indicate that the second advertisement triggers an unauthorized action comprising a forced scrolling of the webpage.

In some variations, the analytics data can further include a type and/or a version of the browser, an operating system at the client, and/or a date and/or time when the second advertisement was rendered.

In some variations, sending at least the portion of the analytics data to the adaptive filter platform can enable the adaptive filter platform to update, based at least on the portion of the analytics data, the block list. The block list can be updated by adding, to the block list, one or more identifiers of the second advertisement, the second advertiser associated with the second advertisement, and/or the second advertising network associated with the second advertisement in response to the analytics data indicating that the second advertisement includes unwanted content, triggers an unauthorized action, and/or degrades the performance of the client.

In another aspect, there is provided a system for adaptively filtering online advertisements at an adaptive filter platform. The system may include at least one data processor and at least one memory. The at least one memory may store instructions that result in operations when executed by the at least one data processor. The operations may include: receiving, from a browser at a client, an indication, the browser loading a webpage that includes at least one advertisement position; in response to receiving the indication from the browser, sending, to the browser, advertisement filter code and a block list, an execution of the advertisement filter code by the browser causing an interception of one or more bids for placing an advertisement in the at least one advertisement position on the webpage, and the interception of the one or more bids preventing a first advertisement from being placed in the at least one advertisement position on the webpage; receiving, from the browser executing the advertisement filter code, analytics data associated with rendering a second advertisement on the webpage; and updating, based at least on the analytics data, the block list.

In some variations, the block list can include one or more identifiers of the first advertisement, the advertiser associated with the first advertisement, and/or the advertising network associated with the first advertisement.

In some variations, the analytics data can indicate that the second advertisement includes unwanted content, triggers an unauthorized action, and/or degrades performance at the client, and wherein the block list is updated to include one or more identifiers of the second advertisement, the advertiser associated with the second advertisement, and/or the advertising network associated with the second advertisement based at least on the second advertisement including the unwanted content, triggering the unauthorized action, and/or degrading the performance at the client.

In some variations, the updated block list can be sent in response to receiving another indication from the browser at the client and/or another browser at another client loading the webpage and/or another webpage.

In some variations, the indication can include a request for the advertisement filter code and/or the block list.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a system diagram illustrating an online advertisement system, consistent with some implementations of the current subject matter;

FIG. 2 depicts a block diagram illustrating an adaptive filter platform, consistent with some implementations of the current subject matter;

FIG. 3A depicts a flowchart illustrating a process for adaptively filtering online advertisements, consistent with some implementations of the current subject matter;

FIG. 3B depicts a flowchart illustrating a process for adaptively filtering online advertisements, consistent with some implementations of the current subject matter;

FIG. 4A depicts a flowchart illustrating a process for detecting audio content and/or video content in an advertisement, consistent with some implementations of the current subject matter;

FIG. 4B depicts a flowchart illustrating a process for detecting redirect advertisements, consistent with some implementations of the current subject matter;

FIG. 4C depicts a flowchart illustrating a process for detecting performance degrading advertisements, consistent with some implementations of the current subject matter;

FIG. 4D depicts a flowchart illustrating a process for detecting forced webpage scrolling, consistent with some implementations of the current subject matter; and

FIG. 5 depicts a block diagram illustrating a computing system, consistent with some implementations of the current subject matter.

When practical, similar reference numbers denote similar structures, features, or elements.

### DETAILED DESCRIPTION

A webpage may often incorporate one or more display advertisements such as, for example, banner advertisements, frame advertisements, and/or the like. As such, loading the webpage may require rendering one or more online advertisements. However, some online advertisements may contain undesirable and/or malicious content. For instance, some online advertisements may contain unwanted content (e.g., audio, video, and/or the like) and/or malware. Some online advertisements may degrade performance at the client loading the webpage. Alternatively and/or additionally, some online advertisements may trigger unauthorized actions such as, for example, automatic redirects to different websites, forced webpage scrolling, and/or the like. Nevertheless, online advertisements may be a primary source of revenue for the publisher of the webpage. Thus, online advertisement blockers that indiscriminately remove all advertisements from the webpage may be impractical because such online advertisement blockers would eliminate advertisement revenue for the publisher altogether.

In some implementations of the current subject matter, an adaptive filter platform may be configured to selectively prevent one or more advertisements from being placed on a webpage. For example, the adaptive filter platform may generate code (e.g., a script, and/or the like) that may be executed by a browser to at least intercept one or more bids for advertisement placement on the webpage. The browser-executable code may be incorporated into the source code for the webpage such that the browser-executable code may be served to a client along with the webpage and executed by a browser loading the webpage. Executing the browser-executable code may remove one or more bids for advertisement placement on the webpage and prevent the corresponding advertisements from being placed on the webpage. In doing so, only a selection of advertisements may be placed on the webpage and rendered during the loading of the webpage. This selection of advertisements may be customized by the publisher of the webpage. For example, the selection of advertisements placed on the webpage may exclude advertisements containing undesirable and/or malicious content (e.g., malware, audio, video, and/or the like), advertisements degrading client performance, advertisements triggering unauthorized actions (e.g., redirects, forced webpage scrolling, and/or the like), and/or the like.

In some implementations of the current subject matter, the browser-executable code may include a block list identifying advertisements, advertisers, and/or advertising networks to exclude from the selection of advertisements placed on the webpage. One or more bids for advertisement placement may be removed in accordance with the block list. Furthermore, the browser-executable code may analyze advertisements rendered on the webpage to generate analytics data. The adaptive filter platform may be configured to update the block list based on the analytics data, which may include data associated with the rendering of one or more advertisements on the webpage. For example, rendering an advertisement may generate data indicative of whether the advertisement includes undesirable and/or malicious content, degrades client performance, triggers an unauthorized action, and/or the like. The adaptive filter platform may be configured to update, based on this analytics data, the block list to include one or more identifiers of the advertisement, the advertiser associated with the advertisement, and/or the advertising network associated with the advertisement.

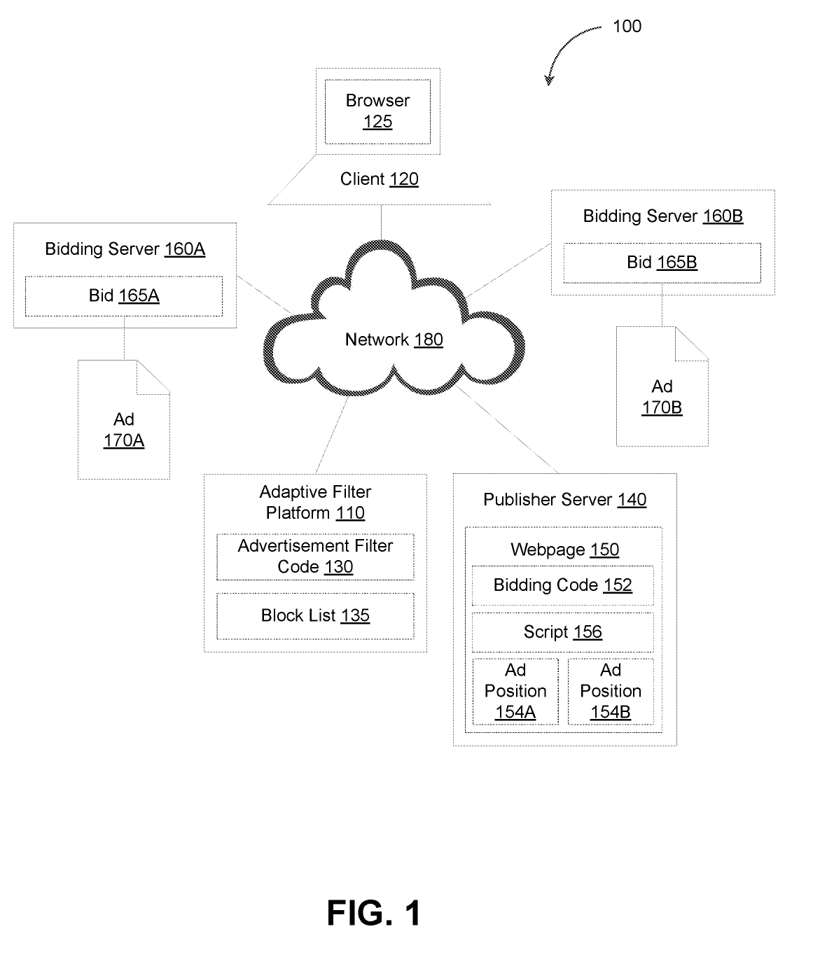

FIG. 1 depicts a system diagram illustrating an online advertising system 100, consistent with some implementations of the current subject matter. Referring to FIG. 1, the online advertising system 100 may include an adaptive filter platform 110, a client 120, and/or a publisher server 140, which may be communicatively coupled via a wired and/or wireless network 180. The client 120 may access, via a browser 125 at the client 120, one or more webpages from the publisher server 140 including, for example, a webpage 150. In response to the client 120 accessing the webpage 150, the publisher server 140 may serve the webpage 150 to the client 120 such that the webpage 150 may be loaded and displayed by the browser 125. As shown in FIG. 1, the webpage 150 may include one or more advertisement positions including, for example, a first advertisement position 154A and a second advertisement position 154B. Thus, loading the webpage 150 may require the browser 125 to also render the online advertisements occupying the first advertisement position 154A and/or the second advertisement position 154B.

The online advertisements placed in the first advertisement position 154A and/or the second advertisement position 154B may be determined via an auction. For example, the source code associated with the webpage 150 may include bidding code 152, which may be header bidding code (e.g., Prebid.js and/or the like) that may be executed by the browser 125 for conducting the auction. Executing the bidding code 152 may cause the solicitation, receipt, and/or processing one or more bids from at least one bidding server including, for example, a first bidding sever 160A and a second bidding server 160B. The advertisements associated with the winning bids may be placed in the first advertisement position 154A and/or the second advertisement position 154B such that loading the webpage 150 may include rendering these advertisements in the first advertisement position 154A and/or the second advertisement position 154B.

The adaptive filter platform 110 may be configured to provide the advertisement filter code 130, which may be code that can be executed by the browser 125 to intercept one or more bids for the auction determining which advertisements are placed in the first advertisement position 154A and/or the second advertisement position 154B. According to some implementations of the current subject matter, the adaptive filter platform 110 may provide the advertisement filter code 130 in response to the webpage 150 being loaded, for example, by the browser 125 at the client 120. For example, the source code associated with the webpage 150 may further include code, for example, a script 156, that can be executed during the loading of the webpage 150 to trigger the download of the advertisement filter code 130 from the adaptive filter platform 110 and/or the execution of the advertisement filter code 130 by the browser 125 at the client 120.

As shown in FIG. 1, the advertisement filter code 130 may include a block list 135, which may specify one or more identifiers of advertisements, advertisers, and/or advertising networks to exclude from the auction. The contents of the block list 135 may correspond to the preferences of the publisher associated with the publisher server 140. Alternatively and/or additionally, the contents of the block list 135 may be determined based on analytics data such as, for example, data associated with the loading of the webpage 150 and/or the rendering of advertisements placed on the webpage 150. Executing the advertisement filter code 130 may intercept and/or remove from the auction bids associated with the one or more identifiers of advertisements, advertisers, and/or advertising networks included in the block list 135.

To further illustrate, the publisher server 140 may serve, to the client 120, the webpage 150. The source code for the webpage 150 may include the bidding code 152, which may be executed to conduct the auction for determining the online advertisements placed in the first advertisement position 154A and/or the second advertisement position 154B. Furthermore, the source code for the webpage 150 can include the script 156, which may be executed to trigger the download of the advertisement filter code 130 from the adaptive filter platform 110 and/or the execution of the advertisement filter code 130 by the browser 125 at the client 120. In some implementations of the current subject matter, executing the script 156, for example, while loading the webpage 150, may cause the adaptive filter platform 110 to provide, to the browser 125 at the client 120, the advertisement filter code 130 and the block list 135. The browser 125 may further execute both the bidding code 152 and the advertisement filter code 130.

By executing the bidding code 152, the browser 125 may solicit a plurality of bids from different advertising networks. It should be appreciated that each bid may correspond to an advertisement from an advertiser and may include the source code for that advertisement. For example, the browser 125 may execute the bidding code 152 to solicit a first bid 165A from the first bidding server 160A and/or a second bid 165B from the second bidding server 160B. The first bid 165A may correspond to a first advertisement 170A while the second bid 165B may correspond to a second advertisement 170B. As such, the first bid 165A may include the source code for the first advertisement 170A and the second bid 165B may include the source code for the second advertisement 170B.

In some implementations of the current subject matter, the browser 125 may also execute the advertisement filter code 130 to selectively prevent one or more advertisements such as, for example, the first advertisement 170A and/or the second advertisement 170B, from being placed on the webpage 150. For example, executing the advertisement filter code 130 may prevent the first advertisement 170A and/or the second advertisement 170B from being placed in a specific advertisement position on the webpage 150 such as, for example, the first advertisement position 154A or the second advertisement position 154B. Alternatively and/or additionally, executing the advertisement filter code 130 may prevent the first advertisement 170A and/or the second advertisement 170B from being placed in any advertisement position on the webpage 150.

According to some implementations of the current subject matter, the browser 125 may selectively prevent the placement of one or more advertisements by at least intercepting and/or removing the corresponding bids from the auction. For example, executing the advertisement filter code 130 may enable the browser 125 to intercept one or more function calls (e.g., all bids received, advertisement rendering, and/or the like) made during the execution of the bidding code 152 that indicate when all of the bids for the first advertising position 154A and/or the second advertising position 154B have been received. In response to intercepting one or more function calls, the browser 125 executing the advertisement filter code 130 may selectively remove the first bid 165A and/or the second bid 165B from all of the bids received for the first advertising position 154A and/or the second advertising position 154B. Selectively removing the first bid 165A and/or the second bid 165B may prevent the browser 125 from evaluating the first bid 165A and/or the second bid 165B when determining the winning bid for each of the first advertising position 154A and/or the second advertising position 154B. Accordingly, the corresponding first advertisement 170A and/or the second advertisement 170B may be prevented from being placed in a specific advertising position (e.g., the first advertising position 154A and/or the second advertising position 154B) and/or from being placed on the webpage 150 altogether.

As noted, the advertisement filter code 130 may include the block list 135, which may include one or more advertisements, advertisers, and/or advertising networks to exclude from the auction. For example, the block list 135 may include one or more identifiers associated with advertisements, advertisers, and/or advertising networks to exclude from the auction. These excluded advertisements, advertisers, and/or advertising networks may correspond to the preferences of the publisher associated with the publisher server 140. Alternatively and/or additionally, the excluded advertisements, advertisers, and/or advertising networks may be determined based on analytics data including, for example, data associated with the loading of the webpage 150 and/or the rendering of one or more advertisements on the webpage 150.

In some implementations of the current subject matter, the browser 125 executing advertisement filter code 130 may selectively remove one or more bids from the auction based at least on the block list 135. For example, the block list 135 may include identifiers associated with the first advertisement 170A, the advertiser associated with the first advertisement 170A, and/or the advertising network associated with the first advertisement 170A. Accordingly, the browser 125 executing advertisement filter code 130 may remove, from the auction, the first bid 165A due to the first bid 165A being associated with the first advertisement 170A, the advertiser associated with the first advertisement 170A, and/or the advertising network associated with the first advertisement 170A.

In some implementations of the current subject matter, the adaptive filter platform 110 may be configured to update the block list 135 based on analytics data generated by the browser 125 executing advertisement filter code 130. This analytics data may include data associated with the rendering of one or more advertisements on the webpage 150 including, for example, data indicative of whether the second advertisement 170B includes unwanted content (e.g., video, audio, and/or the like), triggers an unauthorized action (e.g., a redirect to another webpage, forced webpage scrolling, and/or the like), degrades performance at the client 120, and/or the like. Alternatively and/or additionally, this analytics data may include other relevant data including, for example, the type and/or version of the browser 125, the type of the client 120 (e.g., desktop computer, tablet computer, mobile device, wearable device, and/or the like), the operating system at the client 120, the date and/or time when the advertisement 170B was rendered, and/or the like.

To further illustrate, based on the outcome of the auction, the second advertisement 170B may be placed in the first advertisement position 154A and/or the second advertisement position 154B on the webpage 150. According to some implementations of the current subject matter, the browser 125 executing advertisement filter code 130 may generate analytics data including data associated with the rendering of the second advertisement 170B. The browser 125 may further send, to the adaptive filter platform 110, the analytics data, thereby enabling the adaptive filter platform to update the block list 135 based on this analytics data. For example, the adaptive filter platform 110 may determine, based on the analytics data, whether to include the second advertisement 170B, the advertiser associated with the second advertisement 170B, and/or the advertising network associated with the second advertisement 170B in the block list 135.

Including the second advertisement 170B, the advertiser associated with the second advertisement 170B, and/or the advertising network associated with the second advertisement 170B in the block list 135 may prevent the second advertisement 170B and/or other advertisements originating from the advertiser associated with the second advertisement 170B and/or the advertising network associated with advertisement 170B from being placed in a certain advertising position on a future webpage served by the publisher server 140 and/or any future webpages from the publisher server 140 altogether. According to some implementations of the current subject matter, the adaptive filter platform 110 may include, in the block list 135, one or more identifiers of the advertiser associated with the second advertisement 170B and/or the advertising network associated with advertisement 170B when a threshold quantity of advertisements originating from the advertiser and/or advertising network includes unwanted content (e.g., video, audio, and/or the like), triggers an unauthorized action (e.g., a redirect to another webpage, forced webpage scrolling, and/or the like), degrades the performance at the client 120, and/or the like.

It should be appreciated that the network 180 can be any wired and/or wireless network, such as, for example, a public land mobile network (PLMN), a wide area network (WAN), a local area network (LAN), a virtual local area network (VLAN), the Internet, and/or the like. The client 120 may be any type of processor-based device including, for example, a mobile device, a wearable device, a tablet personal computer (PC), a desktop computer, a laptop computer, and/or the like. Moreover, the online advertising system 100 may include a different quantity of clients, publisher servers, and/or bidding servers than shown.

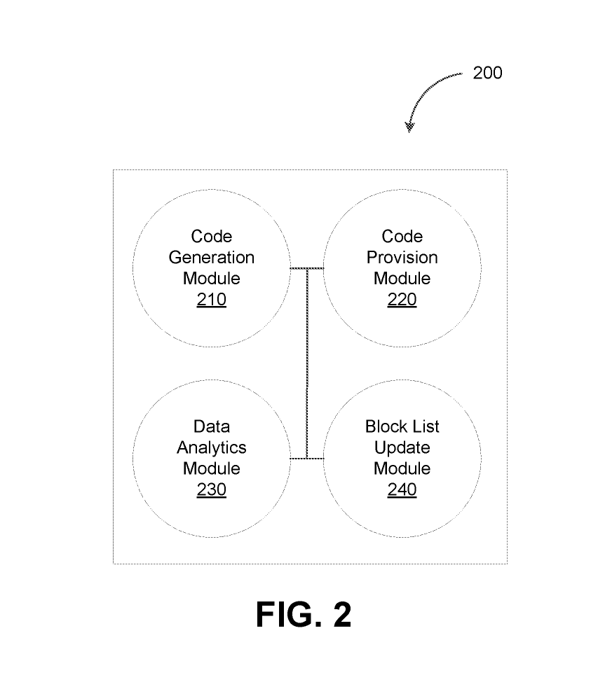

FIG. 2 depicts a block diagram illustrating the adaptive filter platform 110, consistent with some implementations of the current subject matter. Referring to FIGS. 1-2, the adaptive filter platform 110 may include a code generation module 210, a code insertion module 220, a data analytics module 230, and a block list update module 240. It should be appreciated that the adaptive filter platform 110 may include a different quantity and/or different types of modules than shown.

In some implementations of the current subject matter, the code generation module 210 may be configured to generate browser-executable code for intercepting and/or removing one or more bids from an auction. For instance, the code generation module 210 may generate the advertisement filter code 130, which may include the block list 135.

The code provision module 220 may be configured to provide the advertisement filter code 130 generated by the code generation module 210, for example, when the webpage 150 is loaded by the browser 125 at the client 120. For instance, when the browser 125 loads the webpage 150, the browser 125 may execute the script 156 included in the source code of the webpage 150, which may trigger the download of the advertisement filter code 130 from the adaptive filter platform 110 and/or the execution of the advertisement filter code 130 by the browser 125 at the client 120. As noted, executing the advertisement filter code 130 may intercept and/or remove one or more bids (e.g., the first bid 165A and/or the second bid 165B) from an auction for placing one or more advertisements in the first advertisement position 154A and/or the second advertisement position 154B on the webpage 150. The auction may be conducted when the browser 125 executes the bidding code 152 included in the source code of the webpage 150. Intercepting and/or removing the one or more bids may prevent the bids from being evaluated by the browser 125 when the browser 125 determines which advertisements are placed in the first advertisement position 154A and/or the second advertisement position 154B. The interception and/or the removal of the one or more bids may be performed based on the block list 135, which may include identifiers indicating which advertisements, advertisers, and/or advertising networks should be excluded from the auction.

The data analytics module 230 may be configured to determine whether one or more identifiers of an advertisement, an advertiser, and/or an advertising network should be added to a block list, thereby excluding the advertisement, the advertiser, and/or the advertising network from future auctions for advertisement placement. In some implementations of the current subject matter, the contents of the block list may be determined based on the preferences of one or more web publishers. Alternatively and/or additionally, the contents of the block list may be determined based on analytics data.

For instance, the data analytics module 230 may receive, from the browser 125, analytics data that includes data associated with the rendering of the second advertisement 170B originating from the advertiser associated with the second advertisement 170B and/or the advertising network associated with advertisement 170B. This analytics data may indicate whether the second advertisement 170B includes unwanted content (e.g., video, audio, and/or the like), triggers an unauthorized action (e.g., a redirect to another webpage, forced webpage scrolling, and/or the like), degrades performance at the client 120, and/or the like. Alternatively and/or additionally, the analytics data may include other relevant data including, for example, the type and/or version of the browser 125, the type of the client 120 (e.g., desktop computer, tablet computer, mobile device, and/or the like), the operating system at the client 120, the advertisement position for the second advertisement 170B, and/or the like.

In some implementations of the current subject matter, the data analytics module 230 may determine to include one or more identifiers of the second advertisement 170B, the advertiser associated with the second advertisement 170B, and/or the advertising network associated with the second advertisement 170B in the block list 135 if the analytics data indicates that the second advertisement 170B includes unwanted content (e.g., video, audio, and/or the like), triggers an unauthorized action (e.g., a redirect to another webpage, forced webpage scrolling, and/or the like), degrades performance at the client 120, and/or the like. Alternatively and/or additionally, the data analytics module 230 may determine to include one or more identifiers of the advertiser associated with the second advertisement 170B and/or the advertising network associated with the second advertisement 170B in the block list 135 when a threshold quantity of advertisements originating from the advertiser and/or advertising network includes unwanted content (e.g., video, audio, and/or the like), triggers an unauthorized action (e.g., a redirect to another webpage, forced webpage scrolling, and/or the like), degrades performance at the client 120, and/or the like.

The block list update module 240 may be configured to update a block list based on analytics data generated by the browser 125. Alternatively and/or additionally, the block list update module 240 may update the block list based on the preferences of the publisher associated with the publisher server 140. For instance, the block list update module 240 may update the block list 135 to include one or more identifiers of the second advertisement 170B, the advertiser associated with the second advertisement 170B, and/or the advertising network associated with advertisement 170B when analysis performed by the data analytics module 230 indicates that the second advertisement 170B, the advertiser associated with the second advertisement 170B, and/or the advertising network associated with the advertisement 170B should be excluded from future auctions for advertisement placement. The block list update module 240 may also include one or more identifiers of the second advertisement 170B, the advertiser associated with the second advertisement 170B, and/or the advertising network associated with the advertisement 170B in accordance with the preferences of the publisher associated with the publisher server 140. It should be appreciated that the updated block list 135 may be sent along with and/or separate from the advertisement filter code 130 provided by the adaptive filter platform 110 for future webpages served by the publisher server 140.

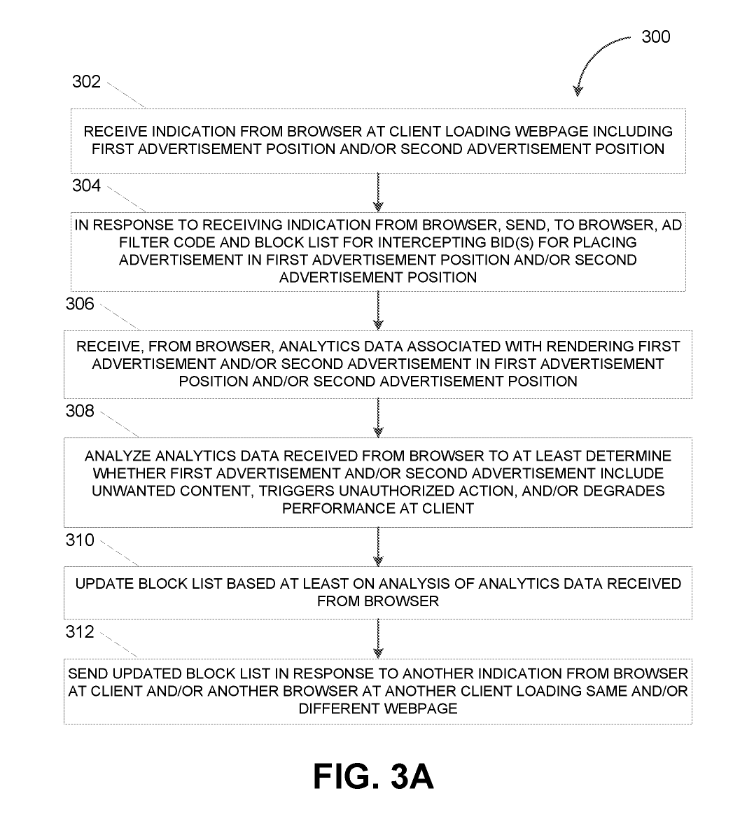

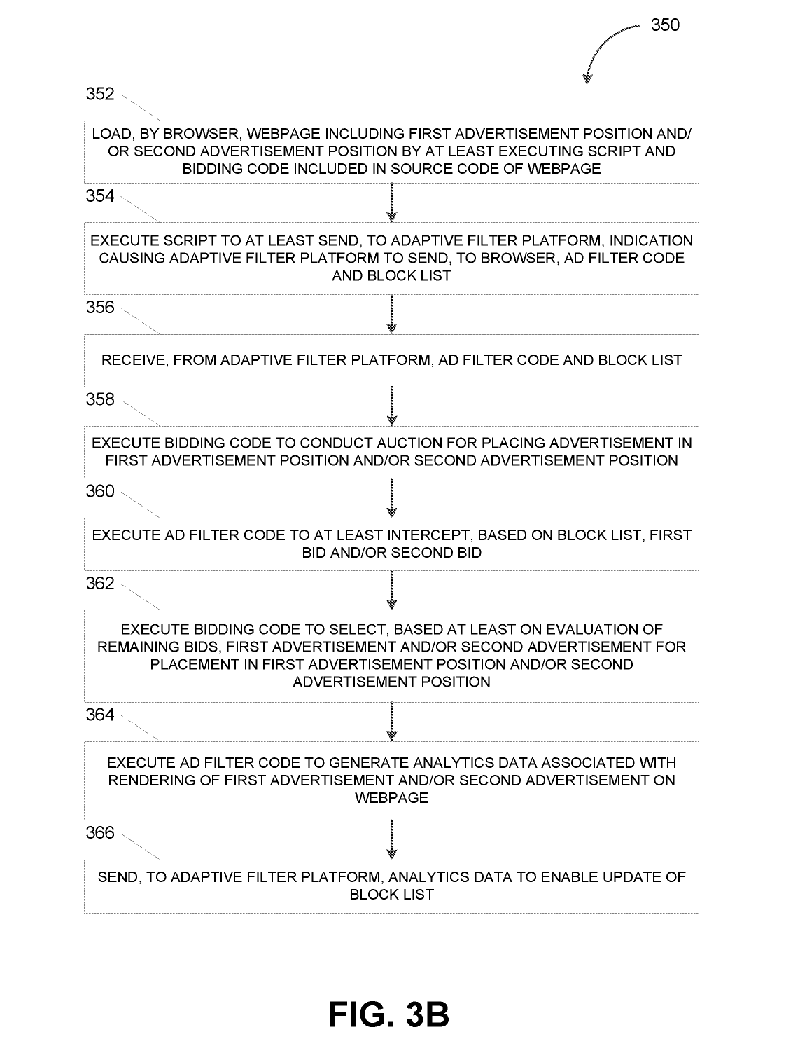

FIG. 3A depicts a flowchart illustrating a process 300 for adaptively filtering online advertisements, consistent with some implementations of the current subject matter. Referring to FIGS. 1-2 and 3A, the process 300 may be performed by adaptive filter platform 110.

The adaptive filter platform 110 may receive an indication from the browser 125 loading the webpage 150 including the first advertisement position 154A and/or the second advertisement position 154B (302). In some implementations of the current subject matter, the browser 125 may load, at the client 120, the webpage 150 including the first advertisement position 154A and/or the second advertisement position 154B. The browser 125 may execute the script 156 when loading the webpage 150. The execution of the script 156 may cause the browser 125 to send, during the loading of the webpage 150, an indication to the adaptive filter platform 110. This indication may include a request for the advertisement filtering code 130 and/or the block list 135 and may thus trigger the adaptive filter platform 110 to send, to the browser 125, the advertisement filter code 130 and the block list 135. Furthermore, the browser 125 executing the script 156 may further execute the advertisement filter code 130 downloaded from the adaptive filter platform 110.

In response to receiving the indication from the browser 125, the adaptive filter platform 110 may send, to the browser 125, the advertisement filter code 130 and the block list 135 for intercepting one or more bids for placing an advertisement in the first advertisement position 154A and/or the second advertisement position 154B on the webpage 150 (304). In some implementations of the current subject matter, upon receiving the indication to request advertisement filter code 130 from the browser 125 at the client 120, the adaptive filter platform 110 may provide, to the browser 125, the advertisement filter code 130 such that the advertisement filter code 130 can be executed by the browser 125 to intercept one or more bids (e.g., the first bid 165A and/or the second bid 165B) for placing an advertisement in the first advertisement position 154A and/or the second advertisement position 154B on the webpage 150.

The adaptive filter platform 110 may receive, from the browser 125 executing the advertisement filter code 130, analytics data associated with rendering the first advertisement 170A and/or the second advertisement 170B in the first advertisement position 154A and/or the second advertisement position 154B (306). In some implementations of the current subject matter, the browser 125 executing the advertisement filter code 130 may generate analytics data that includes data associated with the rendering of the first advertisement 170A and/or the second advertisement 170B in the first advertisement position 154A and/or the second advertisement position 154B. This analytics data may be sent to the adaptive filter platform 110. It should be appreciated that the analytics data may include data indicative of whether the first advertisement 170A and/or the second advertisement 170B includes unwanted content (e.g., video, audio, and/or the like), triggers an unauthorized action (e.g., a redirect to another webpage, forced webpage scrolling, and/or the like), degrades performance at the client 120, and/or the like. Alternatively and/or additionally, the analytics data may include other relevant data including, for example, the type and/or version of the browser 125, the type of the client 120 (e.g., desktop computer, tablet computer, mobile device, and/or the like), the operating system at the client 120, the advertisement position for the second advertisement 170B, and/or the like.

The adaptive filter platform 110 may analyze the analytics data received from the browser 125 to at least determine whether the first advertisement 170A and/or the second advertisement 170B include unwanted content, triggers an unauthorized action, and/or degrades performance at the client 120 (308). The adaptive filter platform 110 may update the block list 135 based at least on the analysis of the analytics data received from the browser 125 (310). In some implementations of the current subject matter, the adaptive filter platform 110 may update the block list 135 based at least on the analysis of the analytics data performed at operation 308. For instance, the adaptive filter platform 110 may update the block list 135 to include the first advertisement 170A and/or the second advertisement 170B, the advertiser associated with the first advertisement 170A and/or the second advertisement 170B, and/or the advertising network associated with the first advertisement 170A and/or the second advertisement 170B in the block list 135 if analysis of the analytics data indicates that the first advertisement 170A and/or the second advertisement 170B include unwanted content (e.g., video, audio, and/or the like), triggers an unauthorized action (e.g., a redirect to another webpage, forced webpage scrolling, and/or the like), degrades performance at the client 120, and/or the like. Alternatively and/or additionally, the data analytics module 230 may determine to include the advertiser associated with the first advertisement 170A and/or the second advertisement 170B, and/or the advertising network operating the first bidding server 160A and/or the second bidding server 160B in the block list 135 when a threshold quantity of advertisements originating from the advertiser and/or advertising network includes unwanted content (e.g., video, audio, and/or the like), triggers an unauthorized action (e.g., a redirect to another webpage, forced webpage scrolling, and/or the like), degrades performance at the client 120, and/or the like.

The adaptive filter platform 110 may send the updated block list 135 in response to another indication from the browser 125 at the client 120 and/or at another browser at another client loading the webpage 150 and/or a different webpage (312). In some implementations of the current subject matter, the browser 125 at the client 120 and/or another browser at a different client can load the webpage 150 and/or a different webpage. During the loading of the webpage 150 and/or the different webpage, the browser 125 at the client 120 and/or the other browser can send an indication that requests at least the updated block list 125. The adaptive filter platform 110 can respond to the request by at least providing, to the browser 125 at the client 120 and/or the other browser at the different client, the updated block list 135. The advertisement filter code 130 may and/or may not be provided along with the updated block list 135. By providing the updated block list 135, the adaptive filter platform 110 can prevent the first advertisement 170A and/or the second advertisement 170B, advertisements from the advertiser associated with the first advertisement 170A and/or the second advertisement 170B, and/or advertisements from the advertising network associated with the first advertisement 170A and/or the second advertisement 170B from being placed on the webpage 150 and/or the different webpage being loaded by the browser 125 at the client 120 and/or by the other browser at the different client.

FIG. 3B depicts a process 350 for adaptive filtering online advertisements, consistent with some implementations of the current subject matter. Referring to FIGS. 1-2 and 3B, the process 350 may be performed by the browser 125 at the client 120.

The browser 125 may load the webpage 150 including the first advertisement position 154A and/or the second advertisement position 154B by at least executing the script 156 and the bidding code 152 included in the source code of the webpage 150 (352). In some implementations of the current subject matter, the source code associated with the webpage 150 may include the bidding code 152 and/or the script 156. As noted, executing the bidding code 152 may conduct an auction to determine which advertisements are placed in the first advertisement position 154A and/or the second advertisement position 154B. For instance, executing the bidding code 152 may cause the solicitation, receipt, and/or processing of the first bid 165A from the first bidding server 160A and/or the second bid 165B from the second bidding server 160B. Meanwhile, executing the script 156 may trigger the download of the advertisement filter code 130 from the adaptive filter platform 110 and/or the execution of the advertisement filter code 130.

The browser 125 executing the script 156 may send, to the adaptive filter platform 110, an indication causing the adaptive filter platform 110 to send, to the browser 125, the advertisement filter code 130 and the block list 135 (354). Furthermore, the browser 125 may receive, from the adaptive filter platform 110, the advertisement filter code 130 and the block list 135 (356). In some implementations of the current subject matter, executing the script 156 may trigger the download of the advertisement filter code 130 and/or the execution of the advertisement filter code 130. For instance, while loading the webpage 150, the browser 125 executing the script 156 may send, to the adaptive filter platform 110, an indication that may cause the adaptive filter platform 110 to send the advertisement filter code 130 and the block list 135 to the browser 125. Meanwhile, executing the advertisement filter code 130 may cause the interception of the first bid 165A and/or the second bid 165B, which can prevent the first bid 165A and/or the second bid 165B from being evaluated as part of the auction. Intercepting the first bid 165A and/or the second bid 165B can further prevent the corresponding first advertisement 170A and/or second advertisement 170B from being placed on the webpage 150, for example, in the first advertisement position 154A and/or the second advertisement position 154B.

The browser 125 may execute the bidding code 152 to conduct an auction for placing an advertisement in the first advertisement position 154A and/or the second advertisement position 154B included in the webpage 150 (358). The browser 125 may execute the advertisement filter code 130 to at least intercept, based on the block list 135, the first bid 165A and/or the second bid 165B (360). As noted, the bidding code 152 may be header bidding code (e.g., Prebid.js and/or the like), which may be executed by the browser 125 for conducting an auction that includes soliciting, receiving, and/or processing one or more bids such as, for example, the first bid 165A and/or the second bid 165B. In some implementations of the current subject matter, the browser 125 may execute the advertisement filter code 130 to intercept, based at least on the block list 135, the first bid 165A and/or the second bid 165B. That is, the browser 125 executing the advertisement filter code 130 can selectively remove the first bid 165A and/or the second bid 165B from the auction, thereby preventing the first bid 165A and/or the second bid 165B from being evaluated when determining the winning bid for each of the first advertising position 154A and/or the second advertising position 154B. As such, the first advertisement 170A associated with the first bid 165A and/or the second advertisement 170B associated with the second bid 165B may be prevented from being placed in a specific advertising position (e.g., the first advertising position 154A and/or the second advertising position 154B) and/or from being placed on the webpage 150 altogether.

The browser 125 may execute the bidding code 152 to select, based at least on an evaluation of the remaining bids, the first advertisement 170A and/or the second advertisement 170B for placement in the first advertisement position 154A and/or the second advertisement position 154B (362). For example, the browser 125 executing the bidding code 152 may evaluate the remaining bids in the auction to select the first advertisement 170A and/or the second advertisement 170B for placement in the first advertising position 154A and/or the second advertising position 154B on the webpage 150. As such, loading the webpage 150 may further include rendering the first advertisement 170A and/or the second advertisement 170B.

The browser 125 executing advertisement filter code 130 may generate analytics data associated with the rendering of the first advertisement 170A and/or the second advertisement 170B on the webpage 150 (364). The browser 125 may further send the analytics data to the adaptive filter platform 110 to enable an update of the block list 135 (366). In some implementations of the current subject matter, the browser 125 may generate analytics data that includes data associated with the rendering of the first advertisement 170A and/or the second advertisement 170B on the webpage 150. This analytics data may be sent to the adaptive filter platform 110. It should be appreciated that the analytics data may include data indicative of whether the first advertisement 170A and/or the second advertisement 170B includes unwanted content (e.g., video, audio, and/or the like), triggers an unauthorized action (e.g., a redirect to another webpage, forced webpage scrolling, and/or the like), degrades performance at the client 120, and/or the like. Alternatively and/or additionally, the analytics data may include other relevant data including, for example, the type and/or version of the browser 125, the type of the client 120 (e.g., desktop computer, tablet computer, mobile device, wearable device, and/or the like), the operating system at the client 120, the date and/or time when the first advertisement 170A and/or the second advertisement 170B was rendered, and/or the like.

Table 1 below depicts pseudo programming code implementing the advertisement filter code 130 consistent with some implementations of the current subject matter.

TABLE 1
class BidInterceptor {

constructor(blocklist) {

this.blocklist = blocklist;
this.originalAllBidsReceived = null;
this._allBidsReceived = this.allBidsReceived.bind(this);
this.originalRequestAdPlacementBids = window.requestAdPlacementBids;
window.requestAdPlacementBids = this.requestAdPlacementBids.bind(this);

}
requestAdPlacementBids(params) {

if(this.hasCustomAllBidsReceivedHandler(params)) {

this.originalAllBidsReceived = params.allBidsReceived

}
const newParams = Object.assign(

{ },
params,
{ allBidsReceived: this._allBidsReceived }

);
return this.originalRequestAdPlacementBids(newParams);

}
hasCustomAllBidsReceivedHandler(params) {

return typeof params.allBidsReceived == ‘function’

&& params.allBidsReceived !== this._allBidsReceived;

}
allBidsReceived(bids) {

const filteredBids = this.filterBidsUsingBlockList(bids);
window.changeAllBidsReceivedTo(filteredBids);
if(this.originalAllBidsReceived !== null) {

return this.originalAllBidsReceived(filteredBids);

}
return filteredBids;

}
filterBidsUsingBlockList(bids) (

let filteredBids = [ ];
for(i=0; i<bids.length; i++) {

if(this.shouldInterceptBid(bids[i])) {

continue;

}
filteredBids.push(bids[i]);

}
return filteredBids;

}
shouldInterceptBid(bid) {

blocklistloop: for(let i = 0; i < blocklist.length; i++) {

for(key in blocklist[i]) {

if(!(key in bid)) {

continue blocklistloop;

}
if(bid[key] !== blocklist[i][key]) {

continue blocklistloop;

}

}
return true;

}
return false;

}

}
new BidInterceptor(blocklist=[

{advertisement: ‘example1’},
{advertiser: ‘example2’},
{adNetwork: ‘example3’},
{adNetwork: ‘example4’, advertiser: ‘example5’}

]);

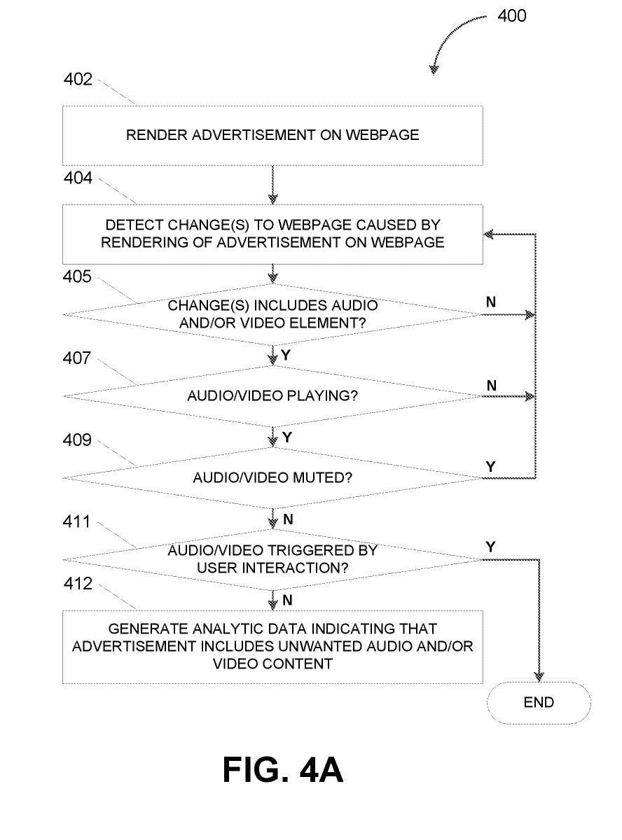

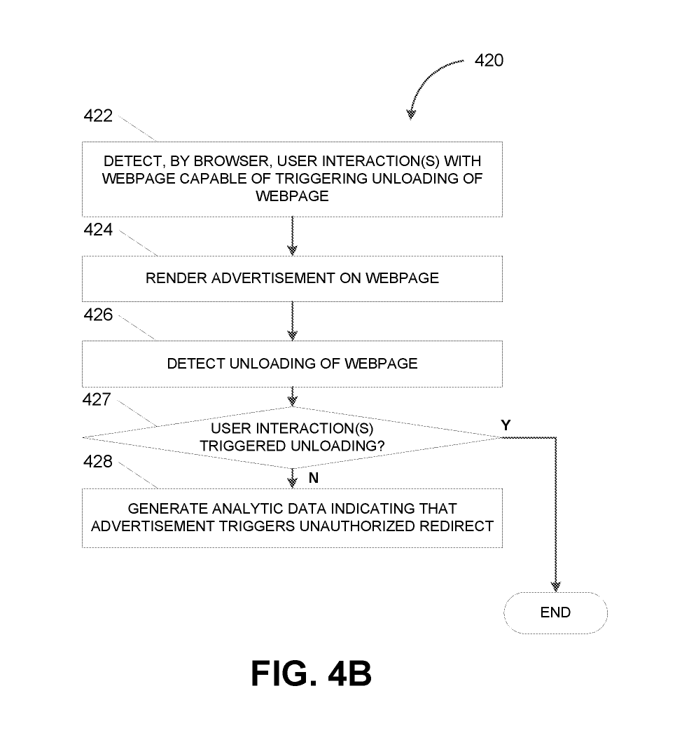

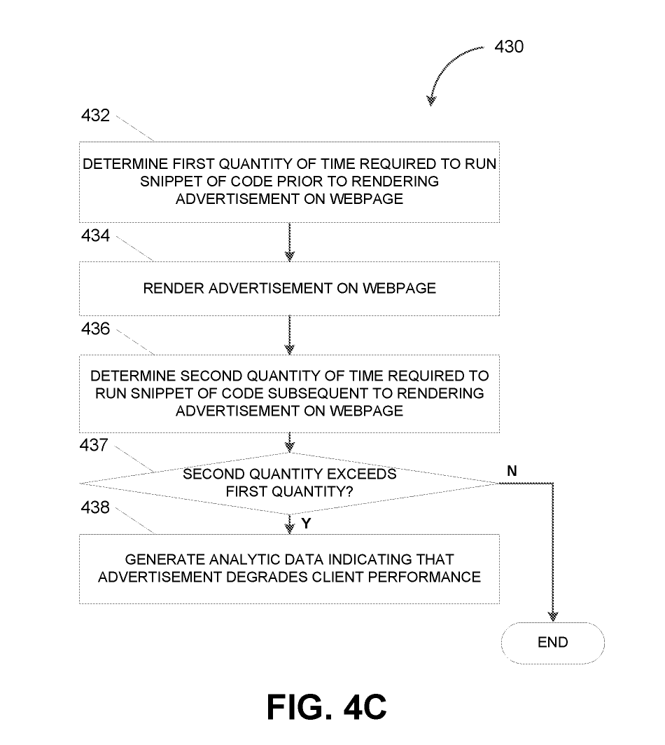

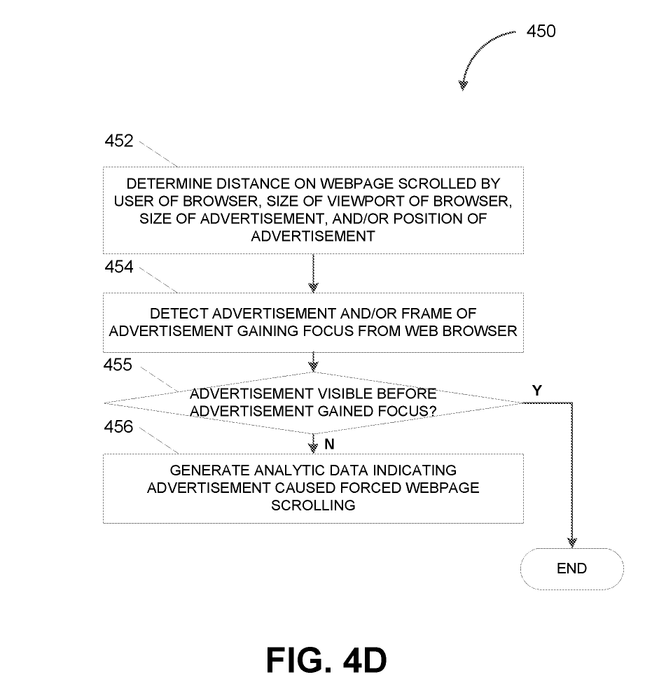

FIG. 4A depicts a flowchart illustrating a process 400 for detecting audio content and/or video content in an advertisement, consistent with some implementations of the current subject matter. Referring to FIGS. 1-2, 3A-B, and 4A, the process 400 may be performed by the browser 125 and may implement operation 364 of the process 350.

The browser 125 can render an advertisement on the webpage 150 (402). For example, in some implementations of the current subject matter, the browser 150 can render the first advertisement 170A and/or the second advertisement 170B on the webpage 150.

The browser 125 executing advertisement filter code 130 may detect one or more changes to the webpage 150 caused by the rendering of the advertisement on the webpage 150 (404). In some implementations of the current subject matter, the browser 125 may be configured to detect changes to the webpage 150 that are caused by the rendering of the first advertisement 170A and/or the second advertisement 170B on the webpage 150.

The browser 125 executing advertisement filter code 130 may determine whether the one or more changes to the webpage 150 include an audio element and/or a video element (405). If the browser 125 determines that the one or more changes do not include an audio element and/or a video element (405-N), the process 400 may continue at operation 404 in which the browser 125 may continue to detect changes to the webpage 150 caused by the rendering of the advertisement on the webpage 150. Alternatively and/or additionally, if the browser 125 determines that the one or more changes do include an audio element and/or a video element (405-Y), the browser 125 may determine whether the audio element and/or the video element is currently playing (407). Here, if the browser 125 determines that the audio element and/or the video element is not currently playing, the process 400 may continue at operation 404 in which the browser 125 may continue to detect changes to the webpage 150 caused by the rendering of the advertisement on the webpage 150. If the browser 125 determines that the audio element and/or the video element is currently playing, the browser 125 may determine whether the audio element and/or the video element has been muted (409). If the browser 125 determines that the audio element and/or the video element has been muted (409-Y), the process 400 may continue at operation 404 in which the browser 125 may continue to detect changes to the webpage 150 caused by the rendering of the advertisement on the webpage 150.

Alternatively and/or additionally, if the browser 125 executing advertisement filter code 130 determines that the audio element and/or the video element has not been muted (409-N), the browser 125 may determine whether user interaction triggered the audio and/or the video playing (411). For instance, the browser 125 may determine whether a user of the browser 125 triggered the audio element and/or the video element by one or more actions such as, for example, clicking on the corresponding first advertisement 170A and/or the second advertisement 170B, and/or the like.

In the event that the browser 125 executing advertisement filter code 130 determines that user interaction did not trigger the playing of the audio and/or the video included in the advertisement (411-N), the browser 125 may generate analytics data indicating that the advertisement includes unwanted audio content and/or unwanted video content (412). For instance, in some implementations of the current subject matter, the browser 125 may determine that the audio element and/or the video element is not triggered by user interaction such as, for example, clicks on the first advertisement 170A and/or the second advertisement 170B. As such, the browser 125 may generate analytics data indicating that the first advertisement 170A and/or the second advertisement 170B includes unwanted content such as, for example, unwanted audio, unwanted video, and/or the like. As noted, analytics data indicating the presence of unwanted content may cause the adaptive filter platform 110 to update the block list 135 to include the first advertisement 170A and/or the second advertisement 170B, the advertiser associated with the first advertisement 170A and/or the second advertisement 170B, and/or the advertising network associated with the first advertisement 170A and/or the second advertisement 170B. Alternatively and/or additionally, if the browser 125 determines that user interaction did trigger the audio element (411-Y), the process 400 may terminate.

Table 2 below depicts pseudo programming code implementing the process 400 for detecting audio content and/or video content in an advertisement, consistent with some implementations of the current subject matter.

TABLE 2
class AdaptiveFilterAudioAnalytics {

constructor( ) {

this.sentAnalyticsData = false;
this.originalRenderBid = window.renderBid;
window.renderBid = this.renderBid.bind(this);

}
renderBid(target, bid) {

const returnValue = this.originalRenderBid(target, bid);
const postMessageData = JSON.stringify({

adRenderTime: new Date( ).getTime( ),
bid: bid

})
try {

this.injectAudioDetectionCode(target, postMessageData);

} catch(e) { }
return returnValue;

}
injectAudioDetectionCode(target, postMessageData) {

let targetWindow = this.getWindowFromDocument(target);
targetWindow._postMessageTarget = window;
targetWindow._postMessageParams = [

postMessageData,
location.origin

];
const audioDetection = ′″

let clicked = false;
function getHTMLElements( ) {

return document.querySelectorAll(‘audio, video’);

}
function checkHTMLElements( ) {

const elements = getHTMLElements( );
for (let i = 0; i < elements.length; i++) {

if (isHTMLElementPlayingAudio(elements[i])) {

foundAudio(elements[i]);

}

}

}
function isHTMLElementPlayingAudio(elem) {

return !!(

hasHTMLElementPlayed(elem)
&& !isElementPaused(elem)
&& !isElementMuted(elem)

);

}
function isAudioOrVideoElement(elem) {

return !!(

isAudioElement(elem) || isVideoElement(elem)

);

}
function isAudioElement(elem) {

return !!(elem.nodeName === ‘AUDIO’);

}
function isVideoElement(elem) {

return !!(elem.nodeName === ‘VIDEO’);

}
function hasHTMLElementPlayed(elem) {

return elem.duration > 0;

}
function isElementPaused(elem) {

return !!(elem.paused);

}
function isElementMuted(elem) {

return !!(elem.muted);

}
function foundAudio( ) {

if(!clicked) {

window._postMessageTarget.postMessage(

...window._postMessageParams

);

}

}
const seenKeysHash = { };
function checkJavaScriptElements( ) {

for (const key in window) {

if (key in seenKeysHash)

continue;

seenKeysHash[key] = true;
findAudioVideoVariables(key, window[key]);

}

}
function findAudioVideoVariables(key, object) {

if (typeof object !== “object”) {

return;

}
if(isHTMLElement(object)) {

if(isAudioOrVideoElement(object)) {

if(isJavaScriptElementPlayingAudio(object)) {

foundAudio( );
break;

}

}
return;

}
for (const subkey in object) {

findAudioVideoVariables(subkey, object[subkey]);

}

}
function isJavaScriptElementPlayingAudio (elem) {

return !!(

this.hasJavaScriptElementPlayed(elem)
&& !this.isElementPaused(elem)
&& !this.isElementMuted(elem)

);

}
function hasJavaScriptElementPlayed(elem) {

return !!(elem.currentTime > 0);

}
function isHTMLElement(elem) {

let hasModeName = false;
try {

hasModeName = ‘nodeName’ in elem;

}
catch (e) { }
return !!hasNodeName;

}
function logClick( ) {

clicked = true;

}
function init( ) {

if(window.addEventListener) {

window.addEventListener(‘DOMNodeInserted’, checkHTMLElements, true);
window.addEventListener(‘click’, logClick, true);

} else if(window.attachEvent) {

window.attachEvent(‘onDOMNodeInserted’, checkHTMLElements, true);
window.attachEvent(‘onclick’, logClick, true);

}
checkHTMLElements( );
setInterval(checkJavaScriptElements, 2000);

}
init( );

′″;
targetWindow.eval(audioDetection);
if(window.addEventListener) {

window.addEventListener(‘message’, this.audioWasDetected.bind(this), true);

} else if(window.attachEvent) {

window.attachEvent(‘onmessage’, this.audioWasDetected.bind(this), true);

}

}
getWindowFromDocument(doc) {

return doc.defaultView || doc.parentWindow;

}
audioWasDetected(event) {

if(this.sentAnalyticsData) {

return;

}
this.sentAnalyticsData = true;
const xhr = new XMLHttpRequest( );
const requestType = ‘POST’;
const URI = ‘adaptive-filter-platform/receive-analytics’;
const asyncRequest = true;
xhr.open(

requestType,
URI,
asyncRequest

);
let eventDataObject = JSON.parse(event.data);
let analyticsData = JSON.stringify({

currentTime: new Date( ).getTime( ),
adRenderTime: eventDataObject.adRenderTime,
bid: eventDataObject.bid,
userAgent: navigator.userAgent

});
let postData = new FormData( );
postData.set(‘analyticsData’, analyticsData);
xhr.send(postData);

}

}
new AdaptiveFilterAudioAnalytics( );

FIG. 4B depicts a flowchart illustrating a process 420 for detecting redirect advertisements, consistent with some implementations of the current subject matter. Referring to FIGS. 1-3 and 4B, the process 420 may be performed by the browser 125 and may implement operation 364 of the process 350.

The browser 125 executing advertisement filter code 130 may detect one or more user interactions with the webpage 150 that is capable of triggering an unloading of the webpage 150 (422). The browser 125 may render an advertisement on the webpage 150 (424). For example, in some implementations of the current subject matter, the browser 125 may render the first advertisement 170A and/or the second advertisement 170B on the webpage 150. During and/or subsequent to rendering the first advertisement 170A and/or the second advertisement 170B, the browser 125 may detect one or more user interactions that are capable of triggering an unloading of the webpage 150 including, for example, clicks on a link on the webpage 150, clicks on a back button on the browser 125, and/or the like. It should be appreciated that the browser 125 may detect clicks on the back button of the browser 125 based at least on a movement of a mouse cursor across the webpage 150. For instance, the browser 125 may determine that the user may have clicked on the back button on the browser 125 when the mouse cursor has been moved in a certain direction and/or toward a specific area (e.g., upper left hand corner) of the webpage 150.

The browser 125 executing advertisement filter code 130 can detect an unloading of the webpage 150 (426). The browser 125 can determine whether the one or more user interactions triggered the unloading of the webpage 150 (427). If the browser 125 determines that the one or more user interactions did not trigger the unloading of the webpage 150 (427-N), then the browser 125 can generate analytics data indicating that the advertisement triggers an unauthorized redirect (428). For instance, in the event that the browser 125 detects an unloading of the webpage 150, the browser 125 may further determine that the unloading of the webpage 150 was not triggered by any user interactions such as, for example, clicks on a link on the webpage 150, clicks on a back button on the browser 125, and/or the like. As such, the browser 125 can generate analytics data indicating that rendering the first advertisement 170A and/or the second advertisement 170B triggers an unauthorized action such as, for example, an unauthorized redirect away from the webpage 150. Analytics data indicating that the first advertisement 170A and/or the second advertisement 170B trigger an unauthorized action may cause the adaptive filter platform 110 to update the block list 135 to include the first advertisement 170A and/or the second advertisement 170B, the advertiser associated with the first advertisement 170A and/or the second advertisement 170B, and/or the advertising network associated with the first advertisement 170A and/or the second advertisement 170B.

Alternatively and/or additionally, if the browser 125 executing advertisement filter code 130 determines that the unloading of the webpage 150 was triggered by user interaction (427-Y), the process 420 may terminate. For instance, when one or more user interactions did trigger the unloading of the webpage 150, the browser 125 can determine that the rendering of the first advertisement 170A and/or the second advertisement 170B did not trigger any unauthorized actions such as, for example, an unauthorized redirect away from the webpage 150.

FIG. 4C depicts a flowchart illustrating a process 430 for detecting performance degrading advertisements, consistent with some implementations of the current subject matter. Referring to FIGS. 1-3 and 4C, the process 430 may be performed by the browser 125 and may implement operation 364 of the process 350.

The browser 125 executing advertisement filter code 130 can determine a first quantity of time required to run a snippet of code prior to rendering an advertisement on the webpage 150 (432). For example, the browser 125 can determine a quantity of time required to run a snippet of code prior to rendering the first advertisement 170A and/or the second advertisement 170B on the webpage 150.

The browser 125 can render then the advertisement on the webpage (434). For example, the browser 125 may render the first advertisement 170A and/or second advertisement 170B on the webpage 150.

The browser 125 executing advertisement filter code 130 can determine a second quantity of time required to run the snippet of code subsequent to rendering the advertisement on the webpage 150 (436). For example, the browser 125 may run the same snippet of code after rendering the first advertisement 170A and/or the second advertisement 170B on the webpage 150. Furthermore, the browser 125 may determine the quantity of time required to run that same snippet of code after the first advertisement 170A and/or the second advertisement 170B has been rendered on the webpage 150.

The browser 125 executing advertisement filter code 130 can determine whether the second quantity of time exceeds the first quantity of time (437). If the browser 125 determines that the second quantity of time does not exceed the first quantity of time (437-N), the process 430 may terminate. For example, the browser 125 may not detect an increase in the quantity of time required to run the snippet of code before and after rendering the first advertisement 170A and/or the second advertisement 170B on the webpage 150. As such, the browser 125 may determine that the first advertisement 170A and/or the second advertisement 170B do not degrade performance at the client 120.

Alternatively and/or additionally, if the browser 125 executing advertisement filter code 130 determines that the second quantity of time exceeds the first quantity of time (437-Y), the browser 125 can generate analytics data indicating that the advertisement degrades performance at the client 120 (438). For instance, in some implementations of the current subject matter, an increase in the quantity of time required to run the same snippet of code after rendering the first advertisement 170A and/or the second advertisement 170B may indicate a degradation in the performance of the client 120 caused by the rendering of the first advertisement 170A and/or the second advertisement 170B. As such, the browser 125 may generate analytics data indicating that the first advertisement 170A and/or the second advertisement 170B degrades client performance. As noted, analytics data indicating that the first advertisement 170A and/or the second advertisement 170B degrades client performance may cause the adaptive filter platform 110 to update the block list 135 to include the first advertisement 170A and/or the second advertisement 170B, the advertiser associated with the first advertisement 170A and/or the second advertisement 170B, and/or the advertising network associated with the first advertisement 170A and/or the second advertisement 170B.

FIG. 4D depicts a flowchart illustrating a process 450 for detecting forced webpage scrolling, consistent with some implementations of the current subject matter. Referring to FIGS. 1-3 and 4D, the process 450 may be performed by the browser 125 and may implement operation 364 of the process 350.

The browser 125 executing advertisement filter code 130 can determine a distance on the webpage 150 scrolled by a user of the browser 125, a size of a viewport of the browser 125, a size of an advertisement, and/or a position of the advertisement on the webpage 150 (452). The browser 125 can further detect the advertisement and/or a frame of the advertisement gaining focus in the browser 125 (454). For example, the browser 125 can detect the first advertisement 170A and/or the second advertisement 170B gaining focus from the browser 125. Alternatively and/or additionally, the browser 125 can detect a frame of the first advertisement 170A and/or the second advertisement 170B gaining focus in the browser 125. In some example embodiments, the browser 125 can detect the first advertisement 170A and/or the second advertisement 170B gaining focus based on a focus event (e.g., a JavaScript focus event), which may occur whenever an element on the webpage 150, such as the first advertisement 170A and/or the second advertisement 170B, gains focus. It should be appreciated that a focus event may be triggered in a variety of manner including, for example, by a mouse click, a tab navigation, and/or the like.

The browser 125 executing advertisement filter code 130 can determine whether the advertisement is visible when the advertisement and/or the frame of the advertisement gained focus from the browser 125 (455). In some implementations of the current subject matter, the browser 125 can determine whether the first advertisement 170A and/or the second advertisement 170B are visible based at least on the distance on the webpage 150 scrolled by the user of the browser 125, the size of the viewport of browser 125, the position of the first advertisement 170A and/or the second advertisement 170B on the webpage 150 (e.g., the first advertisement position 154A and/or second advertisement position 154B), and/or the size of the first advertisement 170A and/or the second advertisement 170B. For instance, the browser 125 can determine that the first advertisement 170A and/or the second advertisement 170B are visible if the distance scrolled by the user, given the size of the viewport of browser 125 and the size of the first advertisement 170A and/or second advertisement 170B, corresponds to the positions of the first advertisement 170A and/or the second advertisement 170B on the webpage 150 (e.g., the first advertisement position 154A and/or the second advertisement position 154B). By contrast, the browser 125 can determine that the first advertisement 170A and/or the second advertisement 170B are not visible if the distance scrolled by the user, given the size of the viewport of browser 125 and the size of the first advertisement 170A and/or the second advertisement 170B, does not correspond to the positions of the first advertisement 170A and/or the second advertisement 170B on the webpage 150 (e.g., the first advertisement position 154A and/or the second advertisement position 154B). That is, the browser 125 can determine that the first advertisement 170A and/or the second advertisement 170B are visible if the user had scrolled just far enough down the webpage 150 for the first advertisement position 154A and/or the second advertisement position 154B occupied by the first advertisement 170A and/or the second advertisement 170B to be within the viewport of the browser 125 without surpassing the first advertisement position 154A and/or the second advertisement position 154B.

If the browser 125 executing advertisement filter code 130 determines that the advertisement is visible when the advertisement and/or the frame of the advertisement gained focus from the browser 125 (455-Y), the process 450 can terminate. Here, the browser 125 can determine that the first advertisement 170A and/or the second advertisement 170B did not cause a forced scrolling of the webpage 150. Alternatively and/or additionally, if the browser 125 determines that the advertisement 125 is not visible when the advertisement and/or the frame of the advertisement gained focus from the browser 125 (455-N), the browser 125 can generate analytics data indicating that the advertisement caused forced webpage scrolling (456). For instance, the browser 125 can determine that the first advertisement 170A and/or the second advertisement 170B cause a forced scrolling of the webpage 150 if the first advertisement 170A and/or the second advertisement 170B are not visible when the first advertisement 170A and/or the second advertisement 170B gained focus. As such, the browser 125 can generate analytics data indicating that the first advertisement 170A and/or the second advertisement 170B trigger unauthorized action such as, for example, a forced scrolling of the webpage 150. Analytics data indicating that the first advertisement 170A and/or the second advertisement 170B trigger an unauthorized action may cause the adaptive filter platform 110 to update the block list 135 to include the first advertisement 170A and/or the second advertisement 170B, the advertiser associated with the first advertisement 170A and/or the second advertisement 170B, and/or the advertising network associated with the first advertisement 170A and/or the second advertisement 170B.

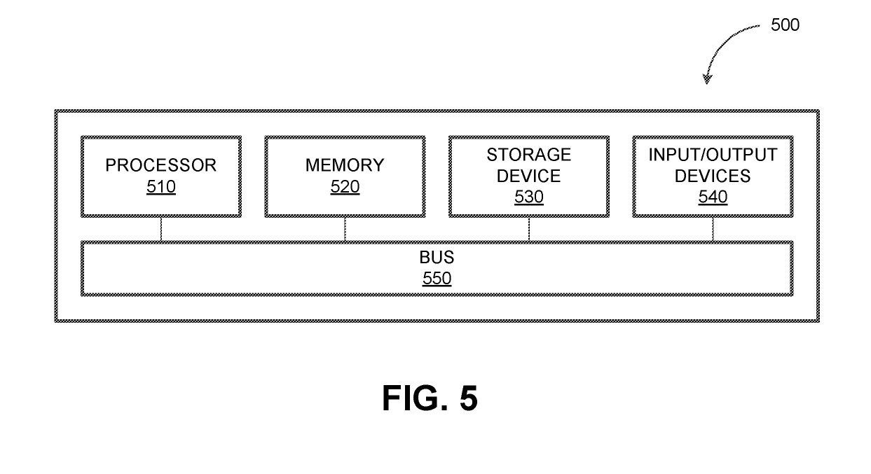

FIG. 5 depicts a block diagram illustrating a computing system 500, consistent with some implementations of the current subject matter. Referring to FIGS. 1 and 5, the computing system 500 can be used to implement the adaptive filter platform 110, the client 120, the publisher server 140, the first bidding server 160A, the second bidding server 160B, and/or any component therein.

As shown in FIG. 5, the computing system 500 can include a processor 510, a memory 520, a storage device 530, and input/output devices 540. The processor 510, the memory 520, the storage device 530, and the input/output devices 540 can be interconnected via a system bus 550. The processor 510 is capable of processing instructions for execution within the computing system 500. Such executed instructions can implement one or more components of, for example, the adaptive filter platform 110, the client 120, the publisher server 140, the first bidding server 160A, and/or the second bidding server 160B. In some example embodiments, the processor 510 can be a single-threaded processor. Alternately, the processor 510 can be a multi-threaded processor. The processor 510 is capable of processing instructions stored in the memory 520 and/or on the storage device 530 to display graphical information for a user interface provided via the input/output device 540.

The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some example embodiments, the input/output device 540 includes a keyboard and/or pointing device. In various implementations, the input/output device 540 includes a display unit for displaying graphical user interfaces.

According to some example embodiments, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some example embodiments, the computing system 500 can be used to execute various interactive computer software applications that can be used for organization, analysis and/or storage of data in various formats. Alternatively, the computing system 500 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method, comprising:
loading, by a browser at a client, a webpage that includes at least one advertisement position;
in response to the loading of the webpage, sending, by the browser and to an adaptive filter platform, an indication configured to cause the adaptive filter platform to send, to the browser, an advertisement filter code and a block list;
in response to the sending of the indication, receiving, at the browser and from the adaptive filter platform, the advertisement filter code and the block list; and
executing, by the browser, the advertisement filter code to intercept one or more bids for placing an advertisement in the at least one advertisement position on the webpage, the one or more bids being intercepted based at least on the block list, and the interception of the one or more bids preventing a corresponding advertisement from being placed in the at least one advertisement position.

2. The method of claim 1, wherein the block list includes one or more identifiers of advertisements, advertisers, and/or advertising networks.

3. The method of claim 2, further comprising:
receiving, at the browser, a first bid and a second bid, the first bid associated with a first adverting network and corresponding to a first advertisement from a first advertiser, and the second bid associated with a second adverting network and corresponding to a second advertisement from a second advertiser; and
intercepting, based at least on the block list, the first bid, the first bid being intercepted based at least on the one or more identifiers of the first advertisement, the first advertiser, and/or the first advertising network being included in the block list.

4. The method of claim 3, further comprising:
rendering, by the browser, the second advertisement in the at least one advertisement position on the webpage;
generating, by the browser executing the advertisement filter code, analytics data based at least on the rendering of the second advertisement, the analytics data indicating whether the second advertisement includes unwanted content, triggers an unauthorized action, and/or degrades performance of the client; and
sending, to the adaptive filter platform, at least a portion of the analytics data.

5. The method of claim 4, wherein the generation of the analytics data comprises:
detecting one or more changes to the webpage caused by the rendering of the second advertisement on the webpage; and
in response to determining that the one or more changes include an audio element and/or video element that is currently playing, has not been muted, and/or is not triggered by user interaction, generating the analytics data to indicate that the second advertisement includes unwanted content.

6. The method of claim 4, wherein the generation of the analytics data comprises:
detecting one or more user interactions with the webpage that are capable of triggering an unloading of the webpage;
detecting the unloading of the webpage; and
in response to determining that the unloading of the webpage is not triggered by the one or more user interactions, generating the analytics data to indicate that the second advertisement triggers an unauthorized action comprising an unauthorized unloading of the webpage.

7. The method of claim 4, wherein the generation of the analytics data comprises:
determining a first quantity of time required to run a snippet of code prior to the rendering of the second advertisement on the webpage;
determining a second quantity of time required to run the snippet of code subsequent to the rendering of the second advertisement on the webpage; and
in response to determining that the second quantity of time exceeds the first quantity of time, generating the analytics data to indicate that the second advertisement degrades the performance at the client.

8. The method of claim 4, wherein the generation of the analytics data comprises:
determining a distance on the webpage scrolled by a user of the browser;
determining a size of a viewport at the browser;
determining a position of the second advertisement on the webpage;
determining a size of the second advertisement;
detecting that the second advertisement and/or a frame of the second advertisement gaining focus from the browser;
determining, based at least on the distance on the webpage scrolled by the user, the size of the viewport at the browser, the position of the second advertisement on the webpage, and/or the size of the second advertisement, that the second advertisement and/or the frame of the second advertisement was not visible when the second advertisement gained focus from the browser; and
in response to determining that the second advertisement was not visible when the second advertisement gained focus from the browser, generating the analytics data to indicate that the second advertisement triggers an unauthorized action comprising a forced scrolling of the webpage.

9. The method of claim 4, wherein the analytics data further includes a type and/or a version of the browser, an operating system at the client, and/or a date and/or time when the second advertisement was rendered.

10. The method of claim 4, wherein sending at least the portion of the analytics data to the adaptive filter platform enables the adaptive filter platform to update, based at least on the portion of the analytics data, the block list, and wherein the block list is updated by adding, to the block list, one or more identifiers of the second advertisement, the second advertiser associated with the second advertisement, and/or the second advertising network associated with the second advertisement in response to the analytics data indicating that the second advertisement includes unwanted content, triggers an unauthorized action, and/or degrades the performance of the client.

11. A method, comprising:
receiving, from a browser at a client, an indication, the browser loading a webpage that includes at least one advertisement position;
in response to receiving the indication from the browser, sending, to the browser, advertisement filter code and a block list, an execution of the advertisement filter code by the browser causing an interception of one or more bids for placing an advertisement in the at least one advertisement position on the webpage, and the interception of the one or more bids preventing a first advertisement from being placed in the at least one advertisement position on the webpage;
receiving, from the browser executing the advertisement filter code, analytics data associated with rendering a second advertisement on the webpage; and
updating, based at least on the analytics data, the block list.

12. The method of claim 11, wherein the block list includes one or more identifiers of the first advertisement, the advertiser associated with the first advertisement, and/or the advertising network associated with the first advertisement.

13. The method of claim 11, wherein the analytics data indicates that the second advertisement includes unwanted content, triggers an unauthorized action, and/or degrades performance at the client, and wherein the block list is updated to include one or more identifiers of the second advertisement, the advertiser associated with the second advertisement, and/or the advertising network associated with the second advertisement based at least on the second advertisement including the unwanted content, triggering the unauthorized action, and/or degrading the performance at the client.

14. The method of claim 11, further comprising:
sending the updated block list in response to receiving another indication from the browser at the client and/or another browser at another client loading the webpage and/or another webpage.

15. The method of claim 11, wherein the indication comprises a request for the advertisement filter code and/or the block list.

16. A system, comprising:
at least one data processor;
at least one memory storing instructions, which when executed by the at least one data processor, result in operations comprising:
loading, by a browser at a client, a webpage that includes at least one advertisement position;
in response to the loading of the webpage, sending, by the browser and to an adaptive filter platform, an indication configured to cause the adaptive filter platform to send, to the browser, an advertisement filter code and a block list;
in response to the sending of the indication, receiving, at the browser and from the adaptive filter platform, the advertisement filter code and the block list; and
executing, by the browser, the advertisement filter code to intercept one or more bids for placing an advertisement in the at least one advertisement position on the webpage, the one or more bids being intercepted based at least on the block list, and the interception of the one or more bids preventing a corresponding advertisement from being placed in the at least one advertisement position.

17. The system of claim 16, wherein the block list includes one or more identifiers of advertisements, advertisers, and/or advertising networks.

18. The system of claim 17, further comprising:
receiving, at the browser, a first bid and a second bid, the first bid associated with a first adverting network and corresponding to a first advertisement from a first advertiser, and the second bid associated with a second adverting network and corresponding to a second advertisement from a second advertiser; and
intercepting, based at least on the block list, the first bid, the first bid being intercepted based at least on the one or more identifiers of the first advertisement, the first advertiser, and/or the first advertising network being included in the block list;

19. The system of claim 18, further comprising:
rendering, by the browser, the second advertisement in the at least one advertisement position on the webpage;
generating, by the browser executing the advertisement filter code, analytics data based at least on the rendering of the second advertisement, the analytics data indicating whether the second advertisement includes unwanted content, triggers an unauthorized action, and/or degrades performance of the client; and
sending, to the adaptive filter platform, at least a portion of the analytics data.

20. The system of claim 19, wherein the generation of the analytics data comprises:
detecting one or more changes to the webpage caused by the rendering of the second advertisement on the webpage; and
in response to determining that the one or more changes include an audio element and/or video element that is currently playing, has not been muted, and/or is not triggered by user interaction, generating the analytics data to indicate that the second advertisement includes unwanted content.

21. The system of claim 19, wherein the generation of the analytics data comprises:
detecting one or more user interactions with the webpage that are capable of triggering an unloading of the webpage;
detecting the unloading of the webpage; and
in response to determining that the unloading of the webpage is not triggered by the one or more user interactions, generating the analytics data to indicate that the second advertisement triggers an unauthorized action comprising an unauthorized unloading of the webpage.

22. The system of claim 19, wherein the generation of the analytics data comprises:
determining a first quantity of time required to run a snippet of code prior to the rendering of the second advertisement on the webpage;
determining a second quantity of time required to run the snippet of code subsequent to the rendering of the second advertisement on the webpage; and
in response to determining that the second quantity of time exceeds the first quantity of time, generating the analytics data to indicate that the second advertisement degrades the performance at the client.

23. The system of claim 19, wherein the generation of the analytics data comprises:
determining a distance on the webpage scrolled by a user of the browser;
determining a size of a viewport at the browser;
determining a position of the second advertisement on the webpage;
determining a size of the second advertisement;
detecting that the second advertisement and/or a frame of the second advertisement gaining focus from the browser;
determining, based at least on the distance on the webpage scrolled by the user, the size of the viewport at the browser, the position of the second advertisement on the webpage, and/or the size of the second advertisement, that the second advertisement and/or the frame of the second advertisement was not visible when the second advertisement gained focus from the browser; and
in response to determining that the second advertisement was not visible when the second advertisement gained focus from the browser, generating the analytics data to indicate that the second advertisement triggers an unauthorized action comprising a forced scrolling of the webpage.

24. The system of claim 19, wherein the analytics data further includes a type and/or a version of the browser, an operating system at the client, and/or a date and/or time when the second advertisement was rendered.

25. The system of claim 19, wherein sending at least the portion of the analytics data to the adaptive filter platform enables the adaptive filter platform to update, based at least on the portion of the analytics data, the block list, and wherein the block list is updated by adding, to the block list, one or more identifiers of the second advertisement, the second advertiser associated with the second advertisement, and/or the second advertising network associated with the second advertisement in response to the analytics data indicating that the second advertisement includes unwanted content, triggers an unauthorized action, and/or degrades the performance of the client.

26. A system, comprising:
at least one data processor;
at least one memory storing instructions, which when executed by the at least one data processor, result in operations comprising:
receiving, from a browser at a client, an indication, the browser loading a webpage that includes at least one advertisement position;
in response to receiving the indication from the browser, sending, to the browser, advertisement filter code and a block list, an execution of the advertisement filter code by the browser causing an interception of one or more bids for placing an advertisement in the at least one advertisement position on the webpage, and the interception of the one or more bids preventing a first advertisement from being placed in the at least one advertisement position on the webpage;
receiving, from the browser executing the advertisement filter code, analytics data associated with rendering a second advertisement on the webpage; and
updating, based at least on the analytics data, the block list.

27. The system of claim 26, wherein the block list includes one or more identifiers of the first advertisement, the advertiser associated with the first advertisement, and/or the advertising network associated with the first advertisement.

28. The system of claim 26, wherein the analytics data indicates that the second advertisement includes unwanted content, triggers an unauthorized action, and/or degrades performance at the client, and wherein the block list is updated to include one or more identifiers of the second advertisement, the advertiser associated with the second advertisement, and/or the advertising network associated with the second advertisement based at least on the second advertisement including the unwanted content, triggering the unauthorized action, and/or degrading the performance at the client.

29. The system of claim 26, further comprising:
sending the updated block list in response to receiving another indication from the browser at the client and/or another browser at another client loading the webpage and/or another webpage.

30. The system of claim 26, wherein the indication comprises a request for the advertisement filter code and/or the block list.

31. A non-transitory computer readable medium storing instructions, which when executed by at least one data processor, result in operations comprising:
loading, by a browser at a client, a webpage that includes at least one advertisement position;
in response to the loading of the webpage, sending, by the browser and to an adaptive filter platform, an indication configured to cause the adaptive filter platform to send, to the browser, an advertisement filter code and a block list;
in response to the sending of the indication, receiving, at the browser and from the adaptive filter platform, the advertisement filter code and the block list; and
executing, by the browser, the advertisement filter code to intercept one or more bids for placing an advertisement in the at least one advertisement position on the webpage, the one or more bids being intercepted based at least on the block list, and the interception of the one or more bids preventing a corresponding advertisement from being placed in the at least one advertisement position.

32. A non-transitory computer readable medium storing instructions, which when executed by at least one data processor, result in operations comprising:
receiving, from a browser at a client, an indication, the browser loading a webpage that includes at least one advertisement position;
in response to receiving the indication from the browser, sending, to the browser, advertisement filter code and a block list, an execution of the advertisement filter code by the browser causing an interception of one or more bids for placing an advertisement in the at least one advertisement position on the webpage, and the interception of the one or more bids preventing a first advertisement from being placed in the at least one advertisement position on the webpage;
receiving, from the browser executing the advertisement filter code, analytics data associated with rendering a second advertisement on the webpage; and
updating, based at least on the analytics data, the block list.
